(19) United States
(12) Patent Application Publication
(10) Pub. No.: US 2010/0141664 A1
(43) Pub. Date: Jun. 10, 2010

(54) Efficient GPU Context Save And Restore For Hosted Graphics

(76) Inventors: Andrew R. Rawson, Austin, TX (US); Mark S. Grossman, Palo Alto, CA (US)

Correspondence Address: HAMILTON & TERRILE, LLP - AMD, P.O. BOX 203518, AUSTIN, TX, 78720, US

(21) Appl. No.: 12/329,995

(22) Filed: Dec. 8, 2008

(51) Int. Cl. G06F 15/16

(52) U.S. Cl. 345/502

(57) ABSTRACT

A computer graphics processing system provides efficient migrating of a GPU context as a result of a context switching operation. More specifically, the efficient migrating provides a graphics processing unit with context switch module which accelerates loading and otherwise accessing context data representing a snapshot of the state of the GPU. The snapshot includes its mapping of GPU content of external memory buffers.

### BACKGROUND OF THE INVENTION

1. Field of the Invention

The present invention relates in general to hosting graphics processing at a centralized location for remote users, and more particularly to efficient context save and restore for hosted graphics.

2. Description of the Related Art

In general, computer system architectures are designed to provide the central processor unit(s) with high speed, high bandwidth access to selected system components (such as random access system memory (RAM) and a graphics processing unit (GPU)), while lower speed and bandwidth access is provided to other, lower priority components (such as the Network Interface Controller (NIC), and read only memory (ROM). For example, FIG. 1 illustrates an example architecture for a conventional computer system 100. The computer system 100 includes a processor 102, a fast or “north” bridge 104, system memory 106, a graphics processing unit (GPU) 108, a network interface card (NIC) 124, a Peripheral Component Interconnect (PCI) bus 110, a slow or “south” bridge 112, a serial advanced technology (SATA) interface 114, an SMBus 115, a universal serial bus (USB) interface 116, a Low Pin Count (LPC) bus 118, and BIOS memory 122. It will be appreciated that other buses, devices, and/or subsystems may be included in the computer system 100 as desired, such as caches, modems, parallel or serial interfaces, SCSI interfaces, etc. Also, the north bridge 104 and the south bridge 112 may be implemented with a single chip or a plurality of chips, leading to the collective term “chipset.” Also, the north bridge 104 may be integrated with the processor 102.

As depicted, the processor 102 is coupled directly to the memory 106 and through the north bridge 104 to the GPU 108 and the PCI bus 110. The north bridge 104 typically provides high speed communications between the CPU 102, GPU 108, and the south bridge 112 via PCI bus 110. In turn, the south bridge 112 provides an interface between the north bridge 104 and various peripherals, devices, and subsystems coupled to the south bridge 112 via the PCI bus 110, SATA interface 114, SMBus 115, USB interface 116, and the LPC bus 118. For example, the BIOS 122 is coupled to the south bridge 112 via the LPC bus 118, while removable peripheral devices (e.g., NIC 124) are connected to the south bridge 112 via the SMBus 115, or inserted into PCI “slots” that connect to the PCI bus 110. The south bridge 112 also provides an interface between the PCI bus 110 and various devices and subsystems, such as a modem, a printer, keyboard, mouse, etc., which are generally coupled to the computer system 100 through the USB 116 or the LPC bus 118, or one of its predecessors, such as an X-bus or an Industry Standard Architecture (ISA) bus. The south bridge 112 includes logic used to interface the devices to the rest of computer system 100 through the SATA interface 114, the USB interface 116, and the LPC bus 118. The south bridge 112 also includes the logic to interface with devices through the SMBus 115, an extension of the two-wire inter-IC bus protocol.

With the conventional arrangement and connection of computer system resources, certain types of computing activities can overload the internal bandwidth capabilities between the CPU and remotely connected devices, such as the GPU 108 and the NIC 124. For example, internal access to shared resources, such as the system memory 106, can be overloaded when the CPU 102 and a remote device (e.g., GPU 108) are both accessing the system memory 106 to transfer data to or from the memory 106. A hosted graphics environment comprises a server type computer system containing a GPU and graphics applications executed and displayed by a remote client. A hosted graphics environment can also comprise executing multiple operating system images where one or more of the operating system images may use the GPU at a given time.

When operating a GPU, a current state and context of a GPU is commonly comprehended as a disjoint set of internal registers, depth buffer contents (such as Z buffer contexts), frame buffer contents and texture map storage buffers. Context switching within a single operating system image involves a number of serial steps orchestrated by the operating system. Within a single operating system image, the GPU may autonomously or under operating system control save and restore internal context state and notify the operating system when the operation is completed. However, if one or more GPUs are to be shared efficiently among multiple applications executing under multiple virtual machines, each executing a graphically oriented operating system and perhaps generating composited graphics on separate thin clients (such as in a hosted graphics environment) migrating a GPU context can be challenging due to, for example, a relatively large amount of GPU state and context in proportion to an amount of available bandwidth and between hardware and software processes. A way to save and restore the state of a given GPU or to move state from one GPU to another in an efficient manner is thus desirable.

### SUMMARY OF THE INVENTION

Broadly speaking, the present invention provides a mechanism for efficiently saving the context of GPU hardware so that it may be shared among a number of different contexts and for efficient migrating of a GPU context from one GPU to another as part of a context switching operation. More specifically, the efficient migrating provides a graphics processing unit with context switch module which accelerates loading and otherwise accessing context data representing a snapshot of the state of the GPU. The snapshot includes both on-chip GPU state and state that may be buffered in external memory.

The context data includes both external working data such as textures, color buffers, vertex buffers, etc. contained in system or video memory and internal state. The latter includes an ordered list of any input graphics commands that have not been completed as well as temporary data, status and configuration bits contained in registers. This internal information is written to a contiguous area of memory referred to as a graphics context control block (GCCB). Also, in certain embodiments, the GPU can accept a pointer to a previously written GCCB and a resume command from software or some other external agent. The pointer may be provided well in advance of when another GPU might be writing out to a GCCB. A set of hardware semaphores is used to synchronize access to the contents of the GCCB and then to individual resources that may be referenced within the GCCB. When granted access, the new GPU is able to read in the GCCB, placing the information in appropriate internal registers, translation look aside buffers (TLBs), page tables, etc. and allows the GPU to resume processing of the context starting from the point at which the context was suspended. In various embodiments, the memory address pointer at which the GCCB is to be written or read can be supplied programmatically by software, transferred to the GPU over an attachment bus or port, or supplied from an internal register within the GPU.

In certain embodiments, the agent that initiates the transfer of the content of the GCCB may be a processor, another GPU or other hardware device. Other triggering events such as hitting a preprogrammed processing time limit or an internal hardware error may also initiate saving of a GCCB to memory.

Also, in certain embodiments, in addition to the context data, the GCCB can store processing hints (e.g., a hint regarding whether a frame is an MPEG I frame or an MPEG P frame boundary), thereby allowing the GPU to determine whether to regenerate portions of a complete context state from high level graphic commands rather than to copy and restore the GPU state from the GCCB.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a simplified architectural block diagram of a conventional computer system.

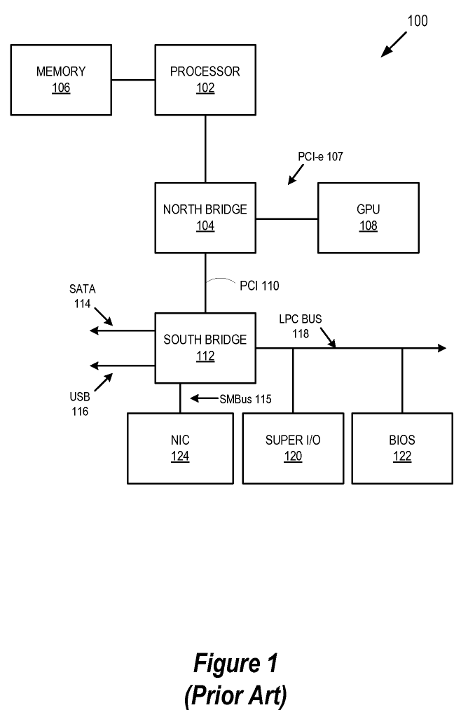

FIG. 2 illustrates a simplified architectural block diagram of a computer system having a plurality of graphics devices in accordance with selected embodiments of the present invention.

FIG. 3 depicts an exemplary flow methodology for performing an efficient context save and restore for hosted graphics.

### DETAILED DESCRIPTION

Various illustrative embodiments of the present invention will now be described in detail with reference to the accompanying figures. While various details are set forth in the following description, it will be appreciated that the present invention may be practiced without these specific details, and that numerous implementation-specific decisions may be made to the invention described herein to achieve the device designer's specific goals, such as compliance with process technology or design-related constraints, which will vary from one implementation to another. While such a development effort might be complex and time-consuming, it would nevertheless be a routine undertaking for those of ordinary skill in the art having the benefit of this disclosure.

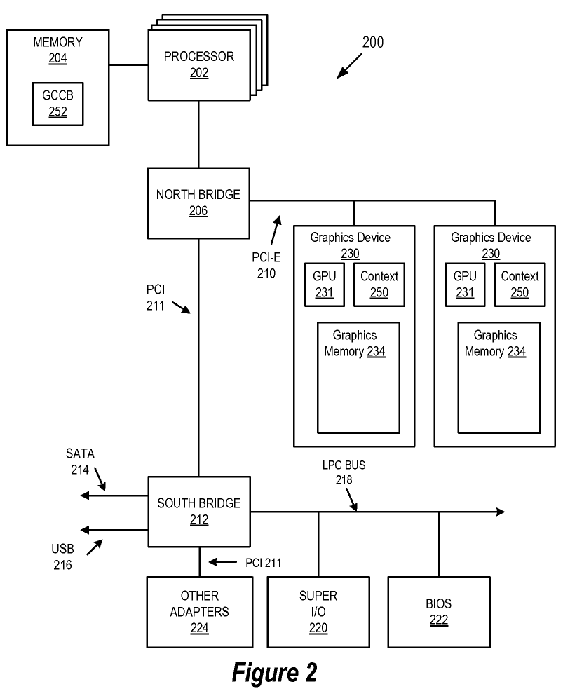

Turning now to FIG. 2, there is depicted a simplified architectural block diagram of a computer system 200 having a plurality of graphics devices 230 in accordance with selected embodiments of the present invention. The depicted computer system 200 includes one or more processors or processor cores 202, memory 204, a north bridge 206, a plurality of graphics devices 230, a PCI Express (PCI-E) bus 210, a PCI bus 211, a south bridge 212, a SATA interface 214, a USB interface 216, an LPC bus 218 and a basic input/output system (BIOS) memory 222 as well as other adapters 224. As will be appreciated, other buses, devices, and/or subsystems may be included in the computer system 200 as desired, e.g. caches, modems, parallel or serial interfaces, SCSI interfaces, etc. In addition, the computer system 200 is shown as including both a north bridge 206 and a south bridge 212, but the north bridge 206 and the south bridge 212 may be implemented with only a single chip or a plurality of chips in the “chipset,” or may be replaced by a single north bridge circuit. Also, the north bridge 206 may be integrated with the processor 202.

By coupling the processor 202 to the north bridge 206, the north bridge 206 provides an interface between the processor 202, the graphics devices 230 (and PCI-E bus 210), and the PCI bus 211. The south bridge 212 provides an interface between the PCI bus 211 and the peripherals, devices, and subsystems coupled to the SATA interface 214, the USB interface 216, and the LPC bus 218. The BIOS 222 is coupled to the LPC bus 218.

The north bridge 206 provides communications access between and/or among the processor 202, the graphics device 230 (and PCI-E bus 210), and devices coupled to the PCI bus 211 through the south bridge 212. The south bridge 212 also provides an interface between the PCI bus 211 and various devices and subsystems, such as a modem, a printer, keyboard, mouse, etc., which are generally coupled to the computer system 200 through the USB 216 or the LPC bus 218 (or its predecessors, such as the X-bus or the ISA bus). The south bridge 212 includes logic used to interface the devices to the rest of computer system 200 through the SATA interface 214, the USB interface 216, and the LPC bus 218.

The computer system 200 may be part of central host server which hosts data and applications for use by one or more remote client devices. For example, the central host server may host a centralized graphics solution which supplies one or more video data streams for display at remote users (e.g. a laptop, PDA, thin client, etc.) to provide a remote PC experience. To this end, the graphics devices 230 are attached to the processor(s) 202 over a high speed, high bandwidth PCI-Express bus 210. Each graphics device 230 includes one or more GPUs 231 as well as graphics memory 234. In operation, the GPU 231 generates computer graphics in response to software executing on the processor(s) 202.

In particular, the software may create data structures or command lists representing the objects to be displayed. Rather than storing the command lists in the system memory 206, the command lists may be stored in the graphics memory 234 where they may be quickly read and processed by the GPU 231 to generate pixel data representing each pixel on the display. Alternately, command lists may be stored in memory 204, in which case a context migration involves passing a pointer rather than having to copy data. The processing by the GPU 231 of the data structures to represent objects to be displayed and the generation of the image data (e.g. pixel data) is referred to as rendering the image. The command list/data structures may be defined in any desired fashion to include a display list of the objects to be displayed (e.g., shapes to be drawn into the image), the depth of each object in the image, textures to be applied to the objects in various texture maps, etc. For any given data stream, the GPU 231 may be idle a relatively large percentage of the time that the system 200 is in operation (e.g. on the order of 90%), but this idle time may be exploited to render image data for additional data streams without impairing the overall performance of the system 200. The GPU 231 may write the pixel data as uncompressed video to a frame buffer in the graphics memory 234 by generating write commands which are transmitted over a dedicated communication interface to the graphics memory 234. However, given the high-speed connection configuration, the GPU 231 may instead write the uncompressed video data may to the system memory 204 without incurring a significant time penalty. Thus, the frame buffer may store uncompressed video data for one or more data streams to be transmitted to a remote user.

The computer system 200 also provides for efficient migrating of a GPU context as a result of a context switching operation. More specifically, the efficient migrating provides each graphics device 230 with a context switch module 250 which accelerates loading and otherwise accessing context data representing a snapshot of the state of the graphics device 230. The snapshot includes both GPU state and state that may be buffered in external memory.

The context data includes an ordered list of any input graphics commands that have not been completed. The context data also include intermediate results such as vertex and fragment lists, and TLB contents. This type of context data may in some cases be passed to another GPU rather than being regenerated (e.g., in the TLB contents case, the cache can be pre-warmed as long as memory resources have not moved). This information is written to a graphics context control block (GCCB) 252 which is stored within a contiguous area of memory 204. Also, in operation, the graphics device 230 can accept a pointer to a previously written GCCB 252 and a resume command from software or some other external agent. The pointer may be provided well in advance of when another graphics device 230 might be writing out to a GCCB 252. The context switch module 250 can control a set of semaphores (e.g., hardware semaphores), where the semaphores may reside in another location in memory 204. Control of the semaphores is used to synchronize access to the contents of the GCCB 252 and then to individual resources that may be referenced within the GCCB. The set of semaphores synchronize and coordinate events within each of the plurality of graphics devices.

When granted access, the new GPU is able to read in the contents of the GCCB 252, placing the information in appropriate internal registers, translation look aside buffers (TLBs), page tables, etc. of the graphics device 230 and allows the graphics device 230 to resume processing of the context starting from the point at which the context was suspended. The memory address pointer at which the GCCB 252 is to be written or read can be supplied programmatically by software, transferred to the graphics device 230 over an attachment bus or port, or supplied from an internal register within the graphics device 230.

The agent that initiates the transfer of the content of the GCCB 252 may be a processor 202, another GPU 231 or other hardware device. Other triggering events such as exceeding a preprogrammed processing time limit or an internal hardware error may also initiate saving of a GCCB 252 to memory 204.

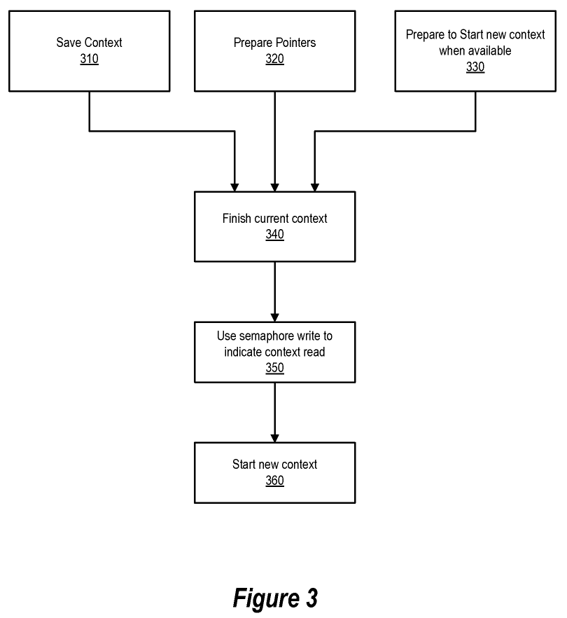

Turning now to FIG. 3, an exemplary method is illustrated for performing an efficient context save and restore for hosted graphics. More specifically, at step 310, the context module 250 (or the various context modules in communication with each other) commands a first graphics device (e.g., GPU0) to save its current context. Also, as step 320, the context module 250 prepares pointers and state copy commands for another graphics device (e.g., GPU1) to start this context when it is available. Also, at step 330, the context module 250 commands the other graphics device to start this context when the device becomes available. Each of steps 310, 320 and 330 may be performed substantially in parallel. That is, none of these steps require results from other of the steps before completing.

After steps 310, 320 and 330 are completed, the context module 250 controls the operation of the first graphics device so that the device finishes a current context, save the context and then uses a semaphore write operation to indicate that the context data has been saved and that access to this data by the first graphics device is relinquished at step 350. Next, at step 360, the other graphics device starts executing using its context data. Before starting operation, the other graphics device reads the semaphore under control of the context module 250 to validate that the graphics device is accessing the appropriate context data.

As described herein, selected aspects of the invention as disclosed above may be implemented in hardware or software. Thus, some portions of the detailed descriptions herein are consequently presented in terms of a hardware implemented process and some portions of the detailed descriptions herein are consequently presented in terms of a software-implemented process involving symbolic representations of operations on data bits within a memory of a computing system or computing device. These descriptions and representations are the means used by those in the art to convey most effectively the substance of their work to others skilled in the art using both hardware and software. The process and operation of both require physical manipulations of physical quantities. In software, usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

The particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

What is claimed is:

1. A computer graphics processing system comprising:
a central processor unit (CPU) comprising at least one processor core;
a system memory;
a plurality of graphics devices coupled to the CPU, each of the plurality of graphics devices comprising a graphics processor unit and a graphics memory;
a context module coupled to each of the plurality of graphics devices, the context module controlling loading context data representing a snapshot of a state of a respective graphics device, the loading of the context data occurring upon a context switch from one of the plurality of graphics devices to another of the plurality of graphics devices.

2. The computer graphics processing system of claim 1 wherein:
the snapshot of the state of a respective graphics device comprises a GPU state of the respective graphics device and state of the respective graphics device that is stored in the system memory.

3. The computer graphics processing system of claim 1 wherein:
the context data comprises an order list of any input graphics commands that have not been completed.

4. The computer graphics processing system of claim 1 further comprising:
a graphics context control block (GCCB) stored in the memory, the graphics context control block storing the context data.

5. The computer graphics processing system of claim 4 wherein:
the graphics device to which the context switch is occurring accepts a pointer to a previously written GCCB and a resume command.

6. The computer graphics processing system of claim 4 wherein:
the context module controls semaphores, the semaphores being used to synchronize access to contents of the GCCB and then to individual resources that are referenced within the GCCB.

7. The computer graphics processing system of claim 1 wherein:
upon switching context, the context data is stored in internal registers, translation look aside buffers (TLBs), and page tables related to the graphics device to which the context is switching.

8. An apparatus for processing graphics comprising:
a plurality of graphics devices coupled to a central processing unit (CPU), each of the plurality of graphics devices comprising a graphics processor unit and a graphics memory;
a context module coupled to each of the plurality of graphics devices, the context module controlling loading context data representing a snapshot of a state of a respective graphics device, the loading of the context data occurring upon a context switch from one of the plurality of graphics devices to another of the plurality of graphics devices.

9. The apparatus of claim 8 wherein:
the snapshot of the state of a respective graphics device comprises a GPU state of the respective graphics device and state of the respective graphics device that is stored in the system memory.

10. The apparatus of claim 8 wherein:
the context data comprises an order list of any input graphics commands that have not been completed.

11. The apparatus of claim 8 further comprising:
a graphics context control block (GCCB), the graphics context control block storing the context data.

12. The apparatus of claim 11 wherein:
the graphics device to which the context switch is occurring accepts a pointer to a previously written GCCB and a resume command.

13. The apparatus of claim 11 wherein:
the context module controls semaphores, the semaphores being used to synchronize access to contents of the GCCB and then to individual resources that are referenced within the GCCB.

14. The apparatus of claim 8 wherein:
upon switching context, the context data is stored in internal registers, translation look aside buffers (TLBs), and page tables related to the graphics device to which the context is switching.
